(19) United States
(12) Patent Application Publication
(10) Pub. No.: US 2008/0276022 A1
(43) Pub. Date: Nov. 6, 2008

(54) Method to Resolve Deadlock in a Bus Architecture Comprising Two Single-Envelope Buses Coupled Via a Bus Bridge and Running Asynchronously

(75) Inventors: Thuyen Le, Taufkirchen (DE); Ralf Ludewig, Schoenalch (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 12/110,609

(22) Filed: Apr. 28, 2008

(30) Foreign Application Priority Data
May 4, 2007 (EP) 07107486.8

(51) Int. Cl. G06F 13/36

(52) U.S. Cl. 710/108

(57) ABSTRACT

A method to resolve a deadlock in a bus architecture comprising a first and a second single-envelope bus with at least one master and one slave each, where the first and second single-envelope buses are arranged on different sides of an asynchronous boundary and are coupled via a bus bridge, said method comprising the steps of:
granting the bus to a first master arranged on a first side of the asynchronous boundary which requests a transaction within a critical time window;
monitoring the bus which has been granted for transaction to the first master;
stealing silently the bus from the first master if a deadlock condition arises;
granting the bus to a second master arranged on a second side of the asynchronous boundary raising the deadlock condition by requesting a second transaction within the critical time window;
completing the second transaction to resolve the deadlock scenario; and
returning back the bus to the first master to complete the first transaction.

Further, a bus architecture to perform said method, a single-envelope bus architecture and a computer system comprising such a bus architecture are described.

### BACKGROUND OF THE INVENTION

The invention relates to a method to resolve the deadlock problem in a pervasive bus architecture of a processor or a system on a chip (SOC) bus architecture in which two asynchronous single-envelope buses arranged on different sides of an asynchronous boundary are coupled by a bus bridge.

Within pervasive bus architecture in a processor or within a system-on-chip (SOC) bus architecture two asynchronous single-envelope buses are coupled by a bus bridge. Thereby single-envelope bus means that once a transaction via the bus bridge is initiated, the transfer has to be completed before another transaction can proceed via said same bus bridge. In other words, a single-envelope bus does neither support a split transaction bus protocol, nor a retry capability of a master.

In such a bus architecture 10 shown in FIG. 1 a so-called deadlock scenario occurs e.g. when a first master A connected to a first single-envelope bus 1 coupled by a first unidirectional bus bridge B12 to a second single-envelope bus 2 wants to access a second slave V connected to the second single-envelope bus 2, wherein within a critical time window also a second master B connected to the second single-envelope bus 2 coupled by a second unidirectional bus bridge B21 with the first single-envelope bus 1 wants to access a first slave U connected to the first single-envelope bus 1. The arrows in FIG. 1 show the direction of access initiation that is equivalent to the address flow. Thereby data can flow in both directions depending on whether read or write access is performed.

This scenario leading to a deadlock is schematically shown in a Message Sequence Chart (MSC) 20 in FIG. 2. The first master A connected to the first single-envelope bus 1 requests the single-envelope bus 1 to perform a read from the second slave V connected to the second single-envelope bus 2. The Arbiter Al (FIG. 1) of the first single-envelope bus 1 grants the bus to the first master A. The bus bridge B12 is selected which then transfers the request over the asynchronous clock boundary AB (FIG. 1) and possibly performs any necessary bus protocol conversion. The master interface of the bus bridge B12 raises a request to the second single-envelope bus 2 which, however, has been granted to the second master B meanwhile, since the second master B within the same critical time window wants to read from the first slave U which is attached to the first single-envelope bus 1. It can be seen that the transferred access of the second master B over the bus bridge B21 will be blocked as well as the access of the bus bridge 12 at the second single-envelope bus 2.

An unsatisfying solution to this problem is the bus architecture 30 shown in FIG. 3. Thereby only a unidirectional bridge B21 is used to connect the first single-envelope bus 1 and the second single-envelope bus 2. Compared to FIG. 1 the bus bridge B12 does not exist. This leads to the situation that a transaction can be initiated only from the second single-envelope bus 2. Further the first master A is connected to the second single-envelope bus 2 via a master interface MI. Since both master A and master B are in the same synchronous domain, the deadlock scenario described due to the critical time window does not exist.

Another known solution is to implement a watchdog timer to detect deadlock conditions and to stop transactions with error in deadlock cases. A disadvantage of this solution is that it does not attack the originate problem directly but just shifts away the deadlock scenario by assuming that it is unlikely that the first master A and the second master B will retry to transfer again at the same time within the same critical time window.

From U.S. Pat. No. 5,933,612 a split transaction is known, wherein the operation of a master providing an address to a slave is split from the operation of the slave responding with appropriate data. This disadvantageously requires complex bus protocols incompatible with single-envelope buses as preliminary quoted, plus split capabilities of masters and slaves.

### SUMMARY OF THE INVENTION

It is therefore an object of the invention to provide a method to resolve deadlocks in a bus architecture having two single-envelope buses running asynchronously that are coupled via a bus bridge. It is further an object of the invention to provide a bus arrangement suited to perform such a method plus a computer system comprising such bus arrangement.

An object of the invention is met by a method according to claim 1, by a bus arrangement according to claim 3 and by a computer system according to claim 6.

Thus a first subject of the invention concerns a method to resolve a deadlock in a bus architecture comprising a first and a second single-envelope bus with at least one master and one slave each, which first and second single-envelope buses are arranged on different sides of an asynchronous boundary, i.e. said buses running asynchronously, and said buses coupled via a bus bridge. Said method comprises the steps of:
granting the bus to a first master located on a first side of the asynchronous boundary, e.g. within the first single-envelope bus, which requests a first transaction, e.g. to a second slave located in the second single-envelope bus, within a critical time window;
monitoring, e.g. by an arbiter, which bus has been granted for transaction to the first master for a deadlock condition, which is met if a further transaction of a second master located on a second side of the asynchronous boundary, e.g. attached to the second single envelope bus, were to begin within the critical time window, i.e. while the bus is granted to the first master;
stealing silently the bus from the first master if a deadlock condition arises, while the bus remains granted to the first master that is waiting for completion;
granting the bus to a second master, e.g. attached to the second single-envelope bus, raising the deadlock condition by requesting a predetermined second transaction, e.g. to a first slave attached to the first single-envelope bus, within the critical time window;
completing the second transaction to resolve the deadlock scenario; and
returning back the bus to the first master to complete the first transaction after the second transaction of the other master has been completed.

Compared to the state of the art the method according to the invention resolves the deadlock problem without altering the functional requirements within the bus architecture. The method according to the invention simply asks to extend the bus controller state machine of either the first single-envelope bus or the second single-envelope bus with some additional states. It is important to mention that it is not necessary to extend the bus controller state machines of both single-envelope buses.

It is important to mention, that the method mentioned above has to be applied to only one single-envelope bus, either the first, or the second single-envelope bus.

A second subject of the invention concerns a bus arrangement comprising a first and a second single-envelope bus with at least one master and slave each, said single envelope buses being arranged on different sides of an asynchronous boundary and being connected via a bus bridge. According to the invention, said bus arrangement comprises:
means to grant the bus to a first master attached to the first single-envelope bus on a first side of the asynchronous boundary, which first master requests a transaction, e.g. to a slave attached to the second single-envelope bus on a second side of the asynchronous boundary;
means to monitor the bus, which has been granted for transaction to the first master, e.g. by a monitoring logic, wherein said monitoring is performed in order to detect whether a deadlock condition is met by a second master attached to the second single-envelope bus on the second side of the asynchronous boundary requesting a predetermined further transaction within a critical time window, i.e. while the bus has been granted to the first master;
means to steal silently the bus from the first master if a deadlock condition arises, while the bus remains granted to the first master that is waiting for completion;
means to grant the bus to the second master raising the deadlock condition;
means to complete the transaction associated with the second master to resolve the deadlock scenario; and
means to return back the bus to the first master to complete the first transaction after the second transaction of the second master has been completed.

Said bus arrangement allows to benefit from all the advantages of the method mentioned above.

In a preferred embodiment of said bus arrangement, the bus bridge is carried out as a bidirectional bus bridge.

In another preferred embodiment of said bus arrangement, the bus bridge is carried out as two unidirectional bus bridges.

According to a particularly preferred embodiment of said bus arrangement, said means to grant the bus to the first master, said means to monitor the bus, said means to steal silently the bus, said means to grant the bus to the second master, said means to complete the transaction associated with the second master and said means to return back the bus to the first master are implemented in one of the single envelope buses.

A third subject of the invention concerns a single-envelope bus for a bus arrangement mentioned above. According to the invention, said single-envelope bus arrangement comprises:
means to grant the bus to a first master attached to the single-envelope bus requesting a first transaction;
means to monitor the bus whether a deadlock condition is met by a second master requesting a second transaction within a critical time window;
means to steal silently the bus from the first master if a deadlock condition arises, while the bus remains granted to the first master that is waiting for completion;
means to grant the bus to the second master raising the deadlock condition;
means to complete the transaction associated with the second master to resolve the deadlock scenario; and
means to return back the bus to the first master to complete the first transaction

A fourth subject of the invention concerns a computer system comprising a bus arrangement as mentioned above.

It is obvious that the invention is not limited to a computer system. For those skilled in the art it is obvious that the method and the bus arrangement according to the invention can also be applied e.g. on a microprocessor design and the like.

### BRIEF DESCRIPTION OF THE DRAWINGS

The foregoing, together with other objects, features, and advantages of this invention can be better appreciated with reference to the following specification, claims and drawings, with

FIG. 1 schematically showing a bus arrangement with two asynchronous single-envelope buses coupled by two unidirectional bus bridges according to the state of the art;

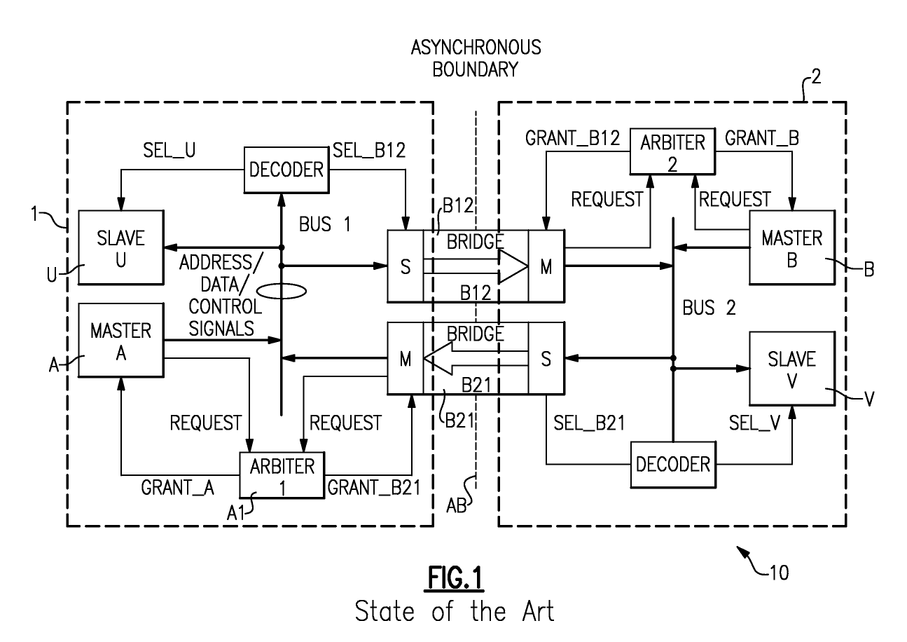

FIG. 2 schematically showing a deadlock scenario within the bus arrangement of FIG. 1 using Message Sequence Chart (MSC);

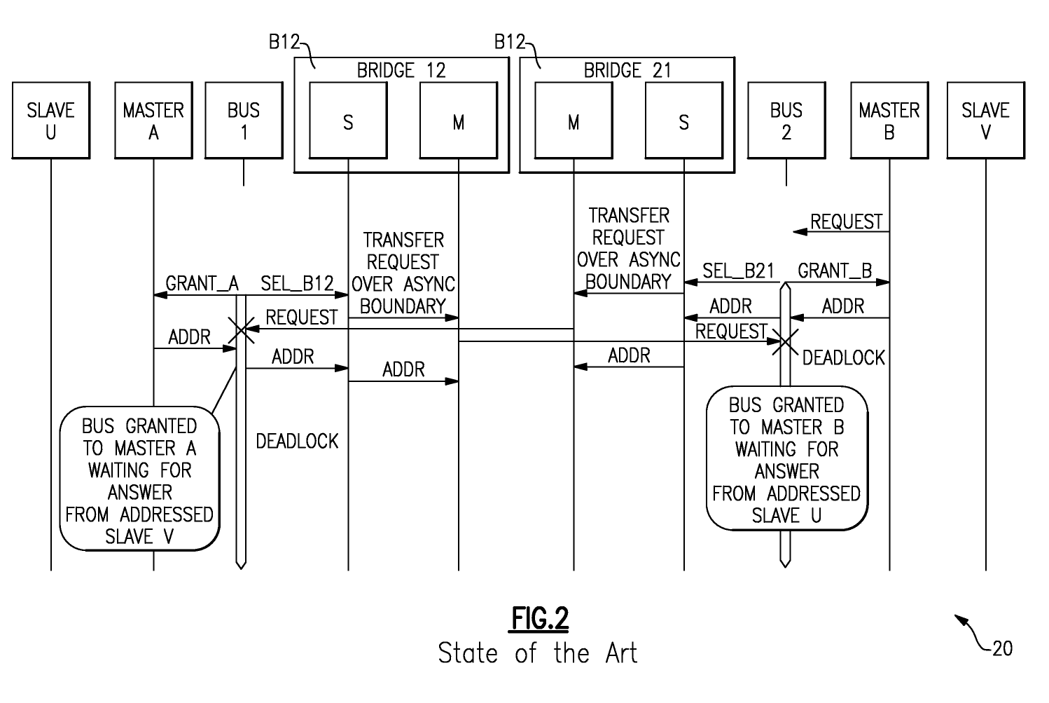

FIG. 3 schematically showing a bus arrangement according to the state of the art providing a disadvantageous solution of a deadlock scenario;

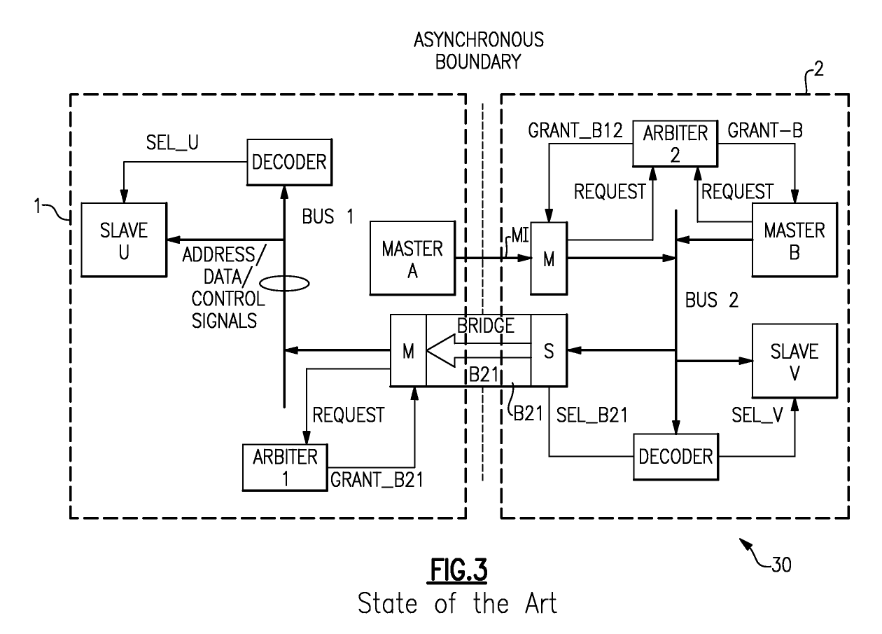

FIG. 4 showing a flow chart of a method according to the invention;

FIG. 5 schematically showing a single-envelope bus arrangement with means to perform the method according to the invention.

### DETAILED DESCRIPTION

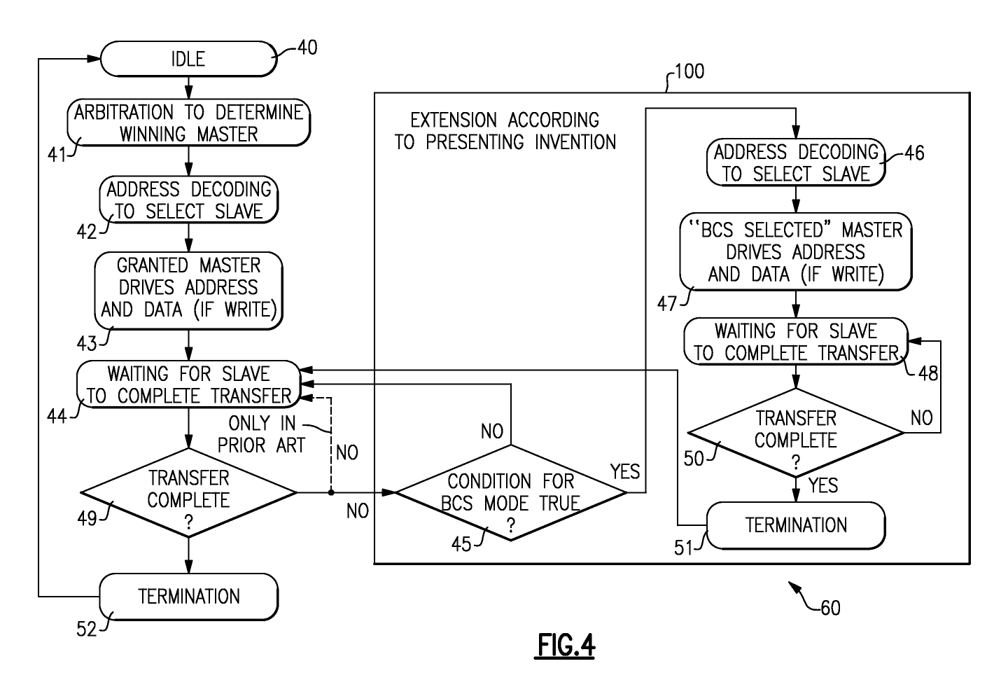

A method according to the invention is performed as shown in the flowchart 60 in FIG. 4.

In an initial state 40, the bus is in idle mode. Then the transaction starts with a first master requesting a transaction.

In the state 41 an arbitration is performed to determine a winning master. If only one master requests a transaction, said master is the winning master. If more than one master request transactions at the same time an arbitration takes place, e.g. according to a priority list for the masters attached to the bus.

In the state 42 the bus is granted to the winning master and an address decoding is performed to select a slave the request of the winning master is directed to.

In the state 43 the winning master drives the address and data on the bus, if the request is a write request. In case of a read request, only the address is driven. A read or write access mode is indicated to the slave by an additional signal.

In the state 44 the granted master waits for the slave to complete the transfer.

In the state 49 it is checked whether the transfer between the granted master and the slave is completed. If so, then the procedure is terminated in state 52 and the bus is in idle state again (initial state 40). If not, then, according to the state of the art, the state 44 and 49 would be repeated until the transfer is completed. A deadlock scenario might lead the bus system to stay forever in the state 44 and 49.

According to the invention, while the transfer between the granted master and the slave is not completed, the bus is monitored in the state 45 whether a deadlock condition arises. If no deadlock condition arises, it is foreseen to jump back to the state 44. If a deadlock condition arises, which is met if a predetermined master attached to this bus raises a request, a Bus Cycle Stealing (BCS) operating mode starts, wherein the bus is silently stolen from the first granted master, i.e. the winning master, while the bus remains granted to the winning master that is waiting for completion.

In the state 46 the bus is granted to the predetermined master that causes the deadlock and an address decoding is performed to select a slave the request of the predetermined master is directed to.

In the state 47 the predetermined master drives the slave address and data, if the request is a write request, or only the address, if the request is a read request.

In the state 48 the second master waits for the slave to complete the transfer.

In the state 50 a decision is made whether the transfer between the predetermined master and the slave is completed. If not, then the ninth step 48 and the tenth step 50 are repeated until the transfer between the predetermined master and the slave is completed. If so, then the BCS operating mode is terminated by step 51 and then the procedure jumps back to the fourth step 44.

Now the steps 45, 49 and 45 are repeated until the transfer between the first master and the slave is completed too. If this occurs, the procedure is terminated in step 52 and the bus is in idle mode again, indicated by the initial state 40.

All steps concerning the BCS mode are surrounded by the box 100 in FIG. 4.

Summarized, a method according to the invention basically comprises the following steps:
granting the bus to a requesting master which within a critical time window first requests a transaction; this master is called winning master;
monitoring the bus which has been granted for transaction to the winning master for deadlock condition which is met if a predetermined further transaction were to begin indicated by a request of a predetermined master;
stealing silently the bus from the winning master if a deadlock condition arises, while the bus remains granted to the winning master that is waiting for completion;
granting the bus to the predetermined master raising the deadlock condition to resolve the deadlock scenario; and
returning back the bus to the winning master to complete its transaction after the transaction of the predetermined master has been completed.

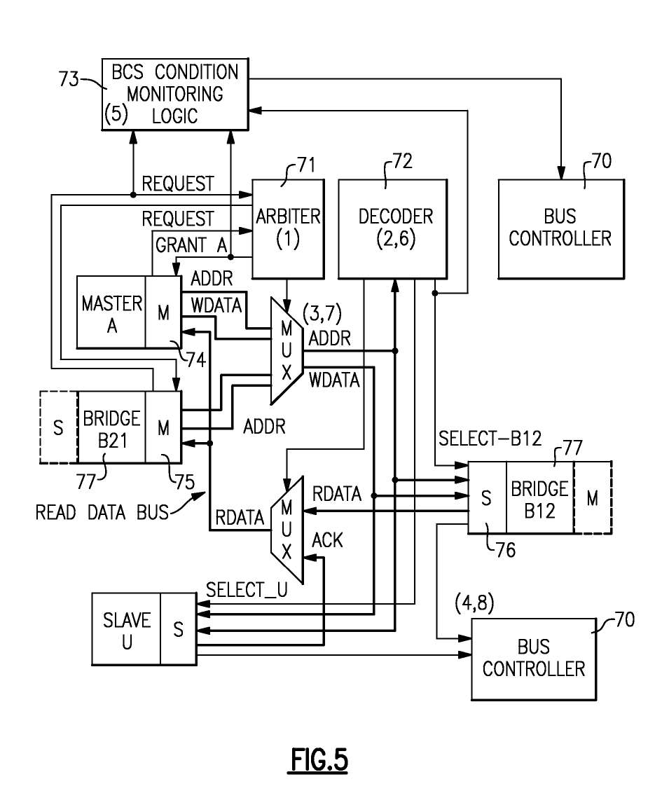

The method according to the present invention with the steps of granting, monitoring, stealing and returning the bus preferably is performed by logic circuit means of the single-envelope bus arrangement in FIG. 5. The bus operation is controlled in general by bus controllers 70. An arbiter 71 determines which master among two requesting masters 74, 75 wins the bus. The address of the winning master is decoded by a bus decoder 72 to generate a slave select signal. A bus bridge 77 is attached to the single-envelope bus via a slave interface 76 and a master interface 75. Thereby, the bus bridge 77 consists of two unidirectional bus bridges 77, wherein it is also thinkable to use a bidirectional bus bridge instead of two unidirectional bus bridges 77. A second single-envelope bus connected via the bus bridge 77 to the single-envelope bus shown in FIG. 5 does not need necessarily to follow the same bus protocol. While the bus has been granted to master 74 to access the slave 76, a BCS condition monitoring logic 73 monitors for deadlock condition which is met if a predetermined further transaction were to begin indicated by the request of the predetermined master, here master 75. Thereby, the predetermined master 75 acts on behalf of a master located in a second single-envelope bus connected to the single-envelope bus shown in FIG. 5 via the bus bridge 77.

It is important to mention that FIG. 5 only depicts the main interaction between the main logic components. For those skilled in the art it is obvious that FIG. 5 can be modified to include other logic circuit means and further interconnections among the logic circuit means.

While the present invention has been described in detail, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. A method to resolve a deadlock in a bus architecture comprising a first and a second single-envelope bus with at least one master and one slave each, wherein said first and said second single-envelope buses are arranged on different sides of an asynchronous boundary and are coupled via a bus bridge, characterized by the steps of:
granting the bus to a first master arranged on a first side of the asynchronous boundary which requests a first transaction within a critical time window;
monitoring the bus which has been granted for transaction to the first master for deadlock condition, which is met if a predetermined further transaction were to begin within the critical time window;
stealing silently the bus from the first master if a deadlock condition arises, while the bus remains granted to the first master that is waiting for completion;
granting the bus to a second master arranged on a second side of the asynchronous boundary raising the deadlock condition by requesting a second transaction within the critical time window;
completing the second transaction to resolve the deadlock scenario; and
returning back the bus to the first master to complete the first transaction.

2. A bus arrangement comprising a first and a second single-envelope bus with at least one master and slave each, said single envelope buses being arranged on different sides of an asynchronous boundary and being connected via a bus bridge, said bus arrangement characterized by:
means (70, 71, 72) to grant the bus to a first master located on a first side of the asynchronous boundary, which first master requests a first transaction;
means (70, 73) to monitor the bus, which has been granted for transaction to the first master, whether a deadlock condition is met by a second master located on the second side of the asynchronous boundary requesting a second transaction within a critical time window;
means (70, 71, 72) to steal silently the bus from the first master if a deadlock condition arises, while the bus remains granted to the first master that is waiting for completion;
means (70, 71, 72) to grant the bus to the second master raising the deadlock condition;
means (70, 71, 72) to complete the transaction associated with the second master to resolve the deadlock scenario; and
means (70, 71, 72) to return back the bus to the first master to complete the first transaction after the second transaction has been completed.

3. Bus arrangement according to claim 2, characterized in that the bus bridge is carried out as a bidirectional bus bridge.

4. Bus arrangement according to claim 2, characterized in that the bus bridge is carried out as two unidirectional bus bridges.

5. Bus arrangement according to claim 2, characterized in that said means to grant the bus to the first master, said means to monitor the bus, said means to steal silently the bus, said means to grant the bus to the second master, said means to complete the transaction associated with the second master and said means to return back the bus to the first master are implemented in one of the single envelope buses.

6. Single-envelope bus for a bus arrangement according to claim 2 characterized by
means (70, 71, 72) to grant the bus to a first master attached to the single-envelope bus requesting a first transaction;
means (70, 73) to monitor the bus whether a deadlock condition is met by a second master requesting a second transaction within a critical time window;
means (70, 71, 72) to steal silently the bus from the first master if a deadlock condition arises, while the bus remains granted to the first master that is waiting for completion;
means (70, 71, 72) to grant the bus to the second master raising the deadlock condition;
means (70, 71, 72) to complete the transaction associated with the second master to resolve the deadlock scenario; and
means (70, 71, 72) to return back the bus to the first master to complete the first transaction.
